(19) United States
(12) Patent Application Publication
(10) Pub. No.: US 2020/0047153 A1
(43) Pub. Date: Feb. 13, 2020

(54) SLURRY FOR TREATMENT OF OXYANION CONTAMINATION IN WATER

(71) Applicant: PHOSLOCK PTY LTD., New South Wales (AU)

(72) Inventor: Andrew Eaton WINKS, New South Wales (AU)

(21) Appl. No.: 16/658,564

(22) Filed: Oct. 21, 2019

Related U.S. Application Data
(62) Division of application No. 14/428,167, filed on Mar. 13, 2015, now abandoned.

(30) Foreign Application Priority Data
Dec. 21, 2012 (AU) 2012905637
Mar. 22, 2013 (CN) 201310093981.4

(51) Int. Cl. B01J 20/12; C02F 1/28; C02F 1/42

(52) U.S. Cl. CPC B01J 20/12; C02F 2103/007; C02F 1/42; C02F 1/281

(57) ABSTRACT

A slurry for treatment of oxyanion contamination in water including: an expandable bentonite having at least 0.50% sodium as disodium monoxide; said bentonite having or being treated to have a sodium content in excess of 3.00% sodium as disodium monoxide so as to provide a sodium activated bentonite; said sodium activated bentonite being treated with rare earth salts selected from lanthanum, cerium, yttrium and dysprosium to provide a plurality of active sequestration sites within or associated with the sodium bentonite.

This invention relates to a slurry for treatment of oxyanion contamination in water. The invention is particularly suited to the treatments of oxyanion contamination in large bodies of water—that is, bodies of water having dimensions in the kilometre range and above as described in more detail hereinunder. However, the invention is not limited to such bodies of water. The invention is an improvement of the slurry described in U.S. Pat. No. 6,350,383, but is not to be taken as being limited to such a basis.

Eutrophication of natural and artificially created bodies of water sometimes leads to oxygen depletion to an extent that the condition of flora and fauna in and about such bodies of water is adversely affected. Under some conditions, toxic blooms of bacteria and/or algae can flourish, rendering the water and its surrounding environment uninhabitable, and sometimes resulting in emission of unpleasant odours. It will be appreciated that anoxic or low oxygen conditions in waters is not necessarily caused by eutrophication. However, remediation of waters and sediments may be achieved by removal of environmental oxyanions in waters prone to eutrophication in many cases.

The remediation material described in the abovementioned United States patent has been effective in the treatment of affected waters and/or their benthic sediments. The teaching in that patent provides for a wide range of materials which vary significantly in efficacy, cost and difficulty of manufacture. A significant difficulty with the materials of the prior art is that of transport because the remediation materials are slurries, the transport of which involves significant volumes of water in which modified clay materials described in the patent are suspended.

For smaller bodies of water, it has been advantageous to granulate the remediation material according to the invention described in our Singapore patent No. 125432. For large bodies of water, it may be convenient to manufacture remediation materials at or close to the shore of the body of water, drawing from the body of water to provide the aqueous phase of the slurry. In this specification, unless the context indicates otherwise, a large body of water refers to a body of water of a size sufficient to justify the manufacture of the slurry on site—that is, on or near the shore of the body of water.

The slurries of the present invention utilise bentonite or montmorillonite clays, the terminology of which varies in the art, along with other terms for clay materials, such as smectite and such like. The clays of interest in the present invention have the property of expandability in water and high cation exchange capacity (CEC). The structure of the clays includes tetrahedral sheets and octahedral sheets. The composition of the clays of interest includes such sheets in varying proportions, along with micro-grains of quartz-like materials and varies depending on the source of the clay. In this specification, the term bentonite refers to naturally occurring bentonite which is amenable to sodium activation and sodium modified bentonites unless the context indicates otherwise. In this specification, the term oxyanion contamination in water is to be taken to include oxyanion contamination in sediments beneath waters likewise contaminated unless the context indicates otherwise.

The present invention aims to provide a slurry for treatment of oxyanion contamination in water which alleviates one or more of the aforementioned problems, or provides an improvement or alternative to remediation materials of the prior art. Other aims and advantages of the invention may become apparent from the following description.

With the foregoing in view, in one aspect the present invention resides broadly in a slurry for treatment of oxyanion contamination in water including:

an expandable bentonite having at least 0.50% sodium as disodium monoxide;

said bentonite having or being treated to have a sodium content in excess of 3.00% sodium as disodium monoxide so as to provide a sodium activated bentonite;

said sodium activated bentonite being treated with rare earth salts selected from lanthanum, cerium, yttrium and dysprosium to provide a plurality of active sequestration sites within or associated with the sodium bentonite.

In another aspect, the present invention resides broadly in a method of manufacture of a slurry for treatment of oxyanion contamination in water including:

selecting an expandable clay from bentonite having at least 0.50% sodium as disodium monoxide;

further selecting or treating said bentonite to have a sodium content in excess of 3.00% sodium as disodium monoxide to provide a sodium activated bentonite;

treating said sodium activated bentonite with rare earth salts selected from lanthanum, cerium, yttrium and dysprosium to provide a plurality of active sequestration sites within or associated with the sodium activated bentonite to provide a rare earth treated bentonite.

In another aspect, the present invention resides broadly in a method of treating waters at a site having oxyanion contamination including:

selecting or treating an expandable clay from bentonite having or to have in excess of 3.00% sodium as disodium monoxide as a sodium activated bentonite;

drying the sodium activated bentonite to a powder or pellet;

transporting the dried sodium activated bentonite to the site;

transporting rare earth salts to the site;

treating the sodium activated bentonite with the rare earth salts and water to provide a rare earth treated bentonite slurry; and

distributing the rare earth treated bentonite slurry about the waters of the site.

Preferably, the rare earth salts are lanthanum and cerium due to their availability, low-toxicity and performance as compared with salts of the other rare earth elements. Lanthanum is more preferred due to its availability and performance in providing sequestration of phosphates in the form of lanthanum phosphate (LaPO₄).

The sequestration sites may be of a form which permits the formation of rhabdophanic or similar types of structures with phosphates, thereby forming a rare earth phosphate complex to effectively sequester the phosphate oxyanion from water or sediment contaminated with such phosphates.

The sodium activated bentonite may be prepared by exchange of at least some of the divalent alkaline earth cations existing therein, such as calcium and magnesium, with sodium cations. Preferably, the source of the sodium cations is sodium carbonate. If the sodium carbonate is provided as soda ash, it is preferred that the soda ash has low bicarbonate content. The sodium activated bentonite may be considered as a sodium activated calcium bentonite with the sodium cation in the exchangeable position of montmorillonite and related smectites known as 2:1 type phyllosilicates. However, the bentonite or sodium activated bentonite is not limited to such form in the provision of a slurry in accordance with the invention.

In order that the invention may be more readily understood and put into practical effect, an exemplary embodiment of the present invention will now be described with reference to the following examples:

### EXAMPLE 1

A slurry in accordance with the invention was prepared by obtaining samples of crude bentonite from Wyoming USA and China which, on testing with XRF, displayed properties of major and minor element composition most suited to sodium activation.

One kg of the raw bentonite was first manually crushed and placed in a lab mulling mixer to which was added a solution of sodium carbonate which imparted a sodium content in excess of 3.00% sodium as disodium monoxide and moisture content of 35%.

The resultant mix was mulled until consistent texture with the bentonite fully wetted and mixed with the sodium carbonate solution. The mulling process reduces the particle size of the bentonite to maximize the surface area available for exposure to the sodium carbonate, thereby maximizing the cation exchange of sodium with bentonite. The mix was then fed into a 50 mm worm extruder with 4 mm orifice plate which provided further mixing and shearing forces as the mix exited as extrudate.

The extrudate was placed in an airtight container and allowed to react for a period up to 30 days after which it was dried for 24 hours at a temperature of 105° C. The dried sodium activated bentonite was comminuted in a plate attrition mill to a particle size of >80% passing 75 μm, <3% retained 200 μm sieve.

A slurry was prepared by adding 135 grams of lanthanum chloride to 4 litres of deionized water and mixed with an overhead vortex mixer at low speed until dissolved. Upon dissolution, 1 kg of the bentonite was added gradually to the solution until completely wetted. The mixer speed was then increased to 1500 RPM for a period of 4 hours to effect the exchange of lanthanum with the sodium. The slurry prepared was then tested for phosphate sequestration. Two litres of deionized water with added reagent grade potassium dihydrogen orthophosphate (KH₂PO₄) to impart a phosphate source of 1 ppm PO₄ as P. 1.8 grams of the prepared slurry was added to the phosphate test water, stirred for 2 minutes and allowed settle for 3 hours to 24 hours. It was found that phosphate was removed from the test water.

Bentonite for the slurry according to the invention may be selected as suitable by field indicators such as colour, soapiness and free swell in water. The bentonite so selected may be further selected by x-ray fluorescence (XRF) analysis for conformity to predetermined criteria as suitable for sodium activation. The crude bentonite is classified to >50 mm and milled and blended with a predetermined amount of aqueous sodium ash solution. The resultant mix, which has a moisture content of about 35%, is then fed into an extruder. The extruder has mixing flights for mixing the materials at high shear and high pressure to achieve intimate contact between the bentonite and the soda ash, the moisture content being sufficient to provide dissociation of the sodium cations for exchange with the divalent cations of the bentonite.

The bentonite is partially activated by the mixer-extrusion process, the extruded bentonite being stored under suitable conditions to maintain its moisture content to mature, normally for about 30 days, to permit the sodium activation to substantially complete, whereupon testing of the sodium activated bentonite is conducted to ensure is has a minimum sodium content of 3.00% as disodium monoxide. Analysis of the bentonite may include determination of the water soluble calcium and magnesium content as a direct indicator of the effectiveness and completion of the sodium activation process.

The test protocol for determining completion of the sodium activation process may be listed as follows:

(a) total hardness—magnesium ion determination;

(b) soluble calcium ion determination (titration method);

(c) alkalinity; and

(d) soluble sodium content (salinity).

A slurry for treatment of oxyanion contamination in water according to the invention may be prepared by treating bentonite sourced, for example, from Wyoming and China, with 4% solution of sodium carbonate dissolved in water to provide a sodium activated bentonite with a sodium content in the amount of 3% as disodium monoxide, and then treated with 12% lanthanum chloride to provide a slurry with a solid content of 25% in water.

The bentonite is selected for its suitability to the task for which it is selected; that is, for substitution of rare earth elements with exchangeable cations of the bentonite. The slurry may be prepared using water from the site where the oxyanion contamination is to be treated. The slurry may be transported in barges or such like for distribution by direct injection into the water column at various depths, injection into the region of sediment/water column interface and surface spray into the water to be treated.

It will be appreciated by persons skilled in the art that the invention is not limited to the particular examples and applications described herein.

1-8. (canceled)

9. A method of remediation of contaminated water having oxyanion contamination comprising the steps of:
selecting an expandable bentonite containing at least 0.5% sodium as disodium monoxide as determined by X-ray fluorescence;
treating the expandable bentonite with a sodium salt to produce a sodium activated bentonite having more than 3% sodium as disodium monoxide as determined by X-ray fluorescence;
combining the sodium activated bentonite with water to produce a sodium activated slurry;
exchanging at least some of the sodium of the sodium activated bentonite with a rare earth salt selected from the group consisting of lanthanum, cerium and dysprosium salt to produce a rare earth exchanged slurry consisting of a rare earth exchanged bentonite and water, the rare earth exchanged bentonite having incorporated therein a rare earth salt, whereby said slurry has a plurality of active sequestration sites, said plurality of active sequestration sites for sequestration of oxyanions; and
distributing the rare earth exchanged slurry in the contaminated water.

10. The method according to claim 9, wherein said rare earth salt is selected from the group consisting of lanthanum salt and cerium salt.

11. The method according to claim 10, wherein said rare earth salt is lanthanum chloride.

12. The method according to claim 9, wherein said rare earth exchanged bentonite of the slurry sequesters phosphate oxyanions in said contaminated water to produce a rare earth phosphate complex.

13. The method according to claim 12, wherein said rare earth phosphate complex forms a rhabdophanic structure with phosphates.

14. The method according to claim 9, wherein said sodium activated bentonite is comminuted to have a particle size of greater than 80% passing a 75 μm sieve and less that 3% retained in a 200 μm sieve.

15. The method according to claim 9, wherein said expandable bentonite is selected to have montmorillonite having exchangeable positions and related 2:1 type phyllosilicates and said sodium activated bentonite includes sodium cations in the exchangeable positions of the montmorillonite and related 2:1 type phyllosilicates.
